(19) United States
(12) Patent Application Publication
(10) Pub. No.: US 2026/0278655 A1
(43) Pub. Date: Sep. 17, 2026

(54) Mobility Platform

(71) Applicant: SHAED, Inc., Minneapolis, MN (US)

(72) Inventors: Ryan Pritchard, Minneapolis, MN (US); Eddie Schick, Minneapolis, MN (US)

(21) Appl. No.: 19/212,501

(22) Filed: May 19, 2025

Related U.S. Application Data
(60) Provisional application No. 63/649,419, filed on May 19, 2024.
(60) Provisional application No. 63/649,432, filed on May 19, 2024.

(51) Int. Cl. G06Q 30/0601; G06Q 30/0283

(52) U.S. Cl. CPC G06Q 30/06212; G06Q 30/0283

(57) ABSTRACT

A vehicle recommendation system comprising: a specialized data normalization architecture comprising a semantic understanding to automatically map diverse data schemas to a unified vehicle representation model; a specialized transformer architecture associated with a graph-based data representation to capture complex multi-stakeholder relationships associated with vehicle transactions and track the temporal evolution of the complex multi-stakeholder relationships; and a multi-objective optimization sub-system comprising reinforcement learning architecture to balance vehicle transactions constraints in real-time by generating optimal transaction parameters.

### CROSS REFERENCE TO RELATED APPLICATIONS

This application claims priority U.S. Provisional Patent Application No. 63/649,419 filed May 19, 2024, entitled “Mobility Platform,” and U.S. Provisional Patent Application No. US 63/649,432 filed May 19, 2024, entitled “Mobility Platform,” which are each incorporated by reference herein in their entirety.

### FIELD

The present disclosure relates to methods and systems for manufacturing or procuring a custom vehicle. More particularly, it relates to an integrated method and system for vehicle manufacturing, sales, financing, services and support.

### BACKGROUND

The commercial vehicle sector is characterized by siloed manufacturing and service processes, as the vehicle manufacturing, sales, financing, and support are handled separately, and often rely on manual methods, spreadsheets, disjointed and incompatible systems that prevent efficient transactions. In some example prior solutions, there has been an attempt to integrate various elements, however, such efforts are either fragmented or only cover specific parts of the process, such as financing options or manufacturing, without offering a comprehensive solution. The process has been traditionally managed through spreadsheets, flat files and verbal agreements. For example, the process of electrifying commercial vehicles is complex and time-consuming, requiring manual coordination across multiple entities, and often leads to inefficiencies, increased costs, and a lack of transparency for all parties involved.

Existing approaches use artificial intelligence techniques which rely on data gathered from multiple data sources to provide insights and recommendations for vehicle procurement. However, these approaches face a multitude of technical challenges, such as: (i) heterogeneous data integration: commercial vehicle specifications, pricing, and configuration data exist in disparate formats across thousands of dealers, OEMs, and service providers. These approaches apply traditional extraction, transformation, loading (ETL) approaches to the received data, however, these traditional ETL approaches fail due to the volume and variety of data sources; (ii) complex multi-stakeholder relationships: commercial (electric vehicles) EV transactions involve numerous interdependent stakeholders (dealers, OEMs, upfitters, charging providers, etc.) with intricate relationship patterns that traditional relational databases struggle to model effectively; (iii) real-time optimization across competing constraints: commercial EV transactions require simultaneous optimization across competing factors (vehicle specifications, charging infrastructure, financial terms, delivery logistics).

Furthermore, existing recommendation systems are not suitable or fail for commercial vehicles. Unlike consumer goods, commercial vehicles have complex interdependencies between specifications, use cases, and infrastructure requirements that standard recommendation algorithms cannot model. In addition, conventional ETL pipelines cannot handle the diversity of data formats. The commercial vehicle ecosystem involves hundreds of different data schemas and formats that continuously evolve, exceeding the capabilities of traditional data integration approaches. Yet another disadvantage with existing or standard neural network architectures is that that they are inefficient for relationship modeling. For example, conventional architectures like convolutional neural networks (CNNs) or standard transformers lack the specialized structure needed to capture the graph-like relationships between stakeholders in the mobility ecosystem. Another problem is that traditional search algorithms perform poorly on partial commercial vehicle specifications. Unlike consumer searches that use simple keyword matching, commercial vehicle searches require semantic understanding of vehicle capabilities and use cases. Conventional optimization algorithms employed in existing systems cannot balance the multi-objective constraints, that is, traditional approaches fail to efficiently navigate the complex trade-off space between vehicle specifications, charging infrastructure, financial terms, and logistics.

### SUMMARY

In one of its aspects, a computer-implemented method for manufacturing a custom vehicle, the method comprising the steps of:
receiving raw data and preprocessing the raw data;
extracting predefined content from the raw data to generate feature vectors;
generating a training data set and a test data set from the feature vector output;
training at least one machine learning model using the training data set and test data set to generate recommendations for the custom vehicle based on at least one of user preferences, vehicle type, body type, components, grants, financing, vehicle support infrastructure, jurisdiction; and
outputting a report comprising information of the custom vehicle for facilitating procurement of the vehicle.

In another aspect, an integrated system for customizing a vehicle, the integrated system comprising:
a computer system comprising a hardware processor and a memory device on which instructions are encoded to cause the hardware processor to perform the operations of:
receiving raw data from a plurality of sources and preprocessing the raw data;
extracting predefined content from the raw data to generate feature vectors;
generating a training data set and a test data set from the feature vector output;
training at least one machine learning model using the training data set and test data set to generate recommendations for the custom vehicle based on at least one of user preferences, vehicle type, body type, components, grants, financing, vehicle support infrastructure, jurisdiction; and
outputting a report comprising information of the custom vehicle for facilitating procurement of the vehicle.

In another aspect, a computer readable medium storing instructions executable by a processor to carry out the operations comprising:
receiving raw data from a plurality of sources and preprocessing the raw data;
extracting predefined content from the raw data to generate feature vectors;
generating a training data set and a test data set from the feature vector output;
training at least one machine learning model using the training data set and test data set to generate recommendations for the custom vehicle based on at least one of user preferences, vehicle type, body type, components, grants, financing, vehicle support infrastructure, jurisdiction; and
outputting a report comprising information of the custom vehicle for facilitating procurement of the vehicle.

In another aspect, an integrated system for vehicle procurement comprising:
a circuit for performing neural network computations for a neural network comprising a plurality of layers, wherein receive raw data from a plurality of data sources, wherein the raw data comprises a plurality of formats, the circuit comprising:
a data normalization layer for transforming raw data in disparate formats acquired from a plurality of data sources into structured data in a standardized data format, and comprising data cleaning and preprocessing techniques to handle missing values and outliers; and for applying feature scaling for consistent ranges across the plurality of data sources;
a feature extraction layer for identifying relevant attributes from the structured data to form training data;
a prediction layer for vehicle pricing and valuation predictions using the training data to train predictive models; and
a recommendation layer comprising collaborative filters to provide personalized vehicle inventory recommendations.

In another aspect, a vehicle recommendation system comprising:
a specialized data normalization architecture comprising a semantic understanding to automatically map diverse data schemas to a unified vehicle representation model;
a specialized transformer architecture associated with a graph-based data representation to capture complex multi-stakeholder relationships associated with vehicle transactions and track the temporal evolution of the complex multi-stakeholder relationships; and
a multi-objective optimization sub-system comprising reinforcement learning architecture to balance vehicle transactions constraints in real-time by generating optimal transaction parameters.

In another aspect, an integrated system for vehicle procurement comprising:
a circuit for performing neural network computations for a neural network comprising a plurality of layers, wherein receive raw data from a plurality of data sources, wherein the raw data comprises a plurality of formats, the circuit comprising:
a data normalization layer for transforming raw data in disparate formats acquired from a plurality of data sources into structured data in a standardized data format, and comprising data cleaning and preprocessing techniques to handle missing values and outliers; and for applying feature scaling for consistent ranges across the plurality of data sources;
a feature extraction layer for identifying relevant attributes from the structured data to form training data;
a prediction layer for vehicle pricing and valuation predictions using the training data to train predictive models; and
a recommendation layer comprising collaborative filters to provide personalized vehicle inventory recommendations.

The methods and systems described herein provide an end-to-end digital solution that unifies manufacturing, sales, and services for the commercial vehicle sector and dealership segments, and generates recommendations using machine learning algorithms and trained models. As such, a comprehensive solution that integrates siloed manufacturing processes and services across the value chain is provided.

By integrating chassis, body, charging infrastructure, financing, and grants into a seamless workflow, the methods and systems described herein significantly reduce time and complexity, streamlining the transition to sustainable energy.

The methods and systems described herein contextualize and processes complex manual tasks, by converting these tasks into digital formats that integrate single-point manufacturing solutions into an ecosystem of interconnected manufacturing processes. In one example, body companies are able to access government grants for appropriate chassis and body information, facilitating their manufacturing, sales, and support processes. A holistic digital process, stitching together the entire manufacturing, sales, and support ecosystem for commercial vehicles is provided.

In one example, the methods and systems provide a consolidated vehicle build package for users. For example, an electric vehicle package including: chassis, body, chargers, infrastructure, utility, finance and grant, may be provided, thereby streamlining the process for end users.

In one example, the digital enablement and algorithms can be extended to additional industries both within and outside the automotive sector, creating comprehensive solutions for diverse markets.

The methods and systems provide a mobility platform tailored for the commercial vehicle sector, which facilitates transitioning from traditional internal combustion engines (ICE) to sustainable solutions and emerging technologies, such as electric vehicles (EVs), autonomous vehicles (AVs), and hydrogen-powered vehicles. The platform offers a comprehensive digital experience, from the initial concept to manufacturing, upfitting, charging, and support services. The platform includes digital automation tools and redefines the existing processes, facilitating transactions for all parties involved in the commercial vehicle lifecycle, including but not limited to procurement, customization, and sales.

The methods and systems reduce the time to integrate new data sources compared to traditional ETL approaches, allowing for rapid onboarding of new dealers and OEMs. In addition, the use of a semantic search system achieves significant relevance accuracy for commercial vehicle searches compared to traditional keyword-based systems. The methods and systems employ multi-objective optimization delivers optimal vehicle configurations and transaction parameters significantly faster than conventional approaches; and platform maintains data consistency across integrated systems, at higher consistency rates compared to fragmented conventional approaches. The methods and systems can adapt to new vehicle categories significantly faster than conventional systems.

As noted previously, the commercial vehicle market suffers from extreme data fragmentation, inconsistent formatting, and incompatible systems that prevent efficient transactions. The methods and systems address the heterogeneous data integration drawback in the conventional approaches by implementing specialized data normalization architecture that uses semantic understanding to automatically map diverse data schemas to a unified vehicle representation model. While traditional ETL approaches are inadequate due to the volume of data in disparate formats received from dealers, OEMs, and service providers, the methods and systems described herein implement specialized data normalization architecture that uses semantic understanding to automatically map diverse data schemas to a unified vehicle representation model. Complex multi-stakeholder relationships that traditional relational databases struggle to model effectively, are modelled via a graph-based data representation combined with a specialized transformer architecture that captures these complex relationships and their temporal evolution. The methods and systems implement real-time optimization across competing constraints via a multi-objective optimization system that employs reinforcement learning to balance these constraints in real-time, generating optimal transaction parameters.

### BRIEF DESCRIPTION OF THE DRAWINGS

FIG. 1 shows a system for a custom vehicle manufacturing and procurement platform;

FIG. 2 shows a flow chart with example steps for generating recommendations for the custom vehicle;

FIG. 3A, with partial views FIGS. 3A1, 3A2, and 3A3, show an overall workflow for vehicle customization;

FIG. 3B shows a workflow outlining how various data sources are integrated into the system;

FIG. 3C shows a workflow outlining the extraction, transformation, and loading (ETL) of data using system's custom algorithms;

FIG. 3D shows a workflow outlining the management and utilization of the system's data warehouse;

FIG. 3E shows a workflow outlining the operations of the system's language model, focusing on data processing and interaction;

FIG. 3F shows a workflow outlining the interaction between users and the web platform;

FIG. 3G shows a workflow outlining the deployment and interaction of various applications;

FIG. 4A shows an example user interface of a sales portal for a search;

FIG. 4B shows an example user interface of a sales portal for customizing a vehicle for procurement;

FIG. 5A shows an example user interface with vehicle listings for purchase;

FIG. 5B shows an example user interface showing potential rebates and incentives; and

FIG. 5C shows an example user interface showing funding and rebate information.

### DETAILED DESCRIPTION

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Moreover, it should be appreciated that the particular implementations shown and described herein are illustrative of the disclosure and are not intended to otherwise limit the scope of the disclosure in any way. Indeed, for the sake of brevity, certain sub-components of the individual operating components, and other functional aspects of the systems may not be described in detail herein. Furthermore, the connecting lines shown in the various figures contained herein are intended to represent example functional relationships and/or physical couplings between the various elements. It should be noted that many alternative or additional functional relationships or physical connections may be present in a practical system.

In one example, the methods and systems provide a mobility platform tailored for the commercial vehicle sector, which facilitates transitioning from traditional internal combustion engines (ICE) to sustainable solutions and emerging technologies, such as electric vehicles (EVs), autonomous vehicles (AVs), and hydrogen-powered vehicles. The platform offers a comprehensive digital experience, from the initial concept to manufacturing, upfitting, charging, and support services. The platform includes digital automation tools and redefines the existing processes, facilitating transactions for all parties involved in the commercial vehicle lifecycle, including but not limited to procurement, customization, and sales. The system employs a microservices architecture with an API-first design that integrates multiple machine learning components to solve the fragmentation and complexity in commercial vehicle transactions, focusing on both ICE and EVs. The architectural components include: (a) a data pipeline architecture, which uses data pipelines for ingesting real-time updates from OEMs, dealerships, and service providers, allowing for normalized data from disparate sources (b) machine learning components, comprising (i) a recommendation engine which uses artificial intelligence to recommend inventory based on user preferences and behavior patterns; (i) predictive analytics for forecasting demand and optimizing inventory using historical transaction data and (iv) configuration tools which use artificial intelligence to validate vehicle configurations and compatibility; (c) an API gateway which provides standardized APIs for seamless connection of new stakeholders and services, enabling the platform to overcome industry fragmentation; and (d) event-driven architecture for supporting real-time coordination across the ecosystem, facilitating multi-stakeholder workflows.

The system may be integrated with charging station networks to acquire real-time data on charging availability and to coordinate installation of new infrastructure, vehicle telematics systems to collect operational data that informs maintenance scheduling and performance analytics, logistics provider systems to enable real-time tracking of vehicle deliveries and transportation status, and energy management systems to optimize vehicle charging schedules and manage power consumption.

These integrations enable the platform to bridge the digital and physical aspects of commercial vehicle operations, and address the core problem of fragmentation in the commercial vehicle industry by creating a unified data model and workflow system that connects previously siloed operations.

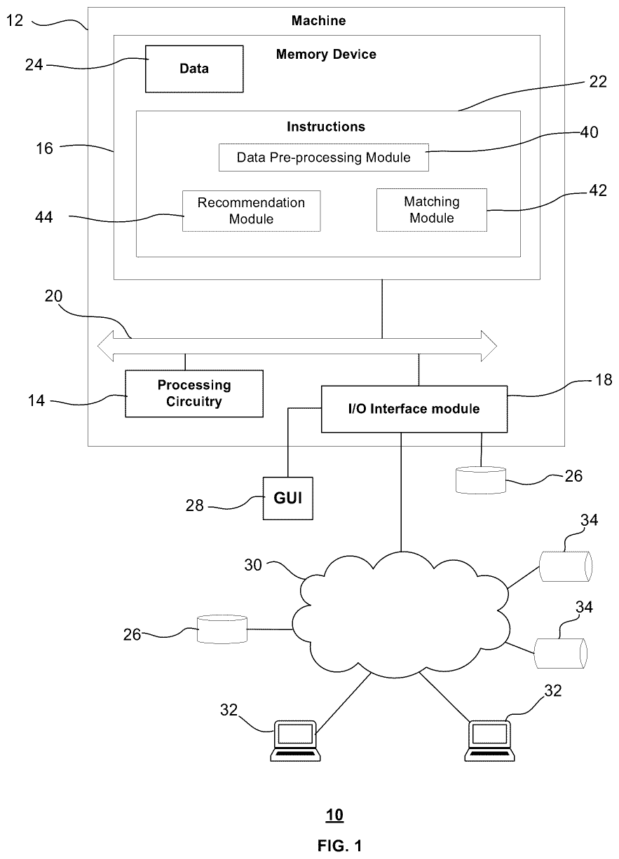

In one example, FIG. 1 shows a system 10 facilitating a mobility platform for a custom vehicle procurement comprising machine or computing system 12 having processing circuitry 14 such as one or more processors, at least one memory device such as memory 16, input/output (I/O) module 18, which are in communication with each other via centralized circuit system 20. Although computing system 12 is depicted to include only one processor 14, computing system 12 may include a number of processors therein. In an embodiment, memory 16 is capable of storing machine executable instructions 22, and data 24, including data models and process models. Database 26 is coupled to computing system 12 and stores pre-processed data, model output data, and so forth. In one example, database 26 comprises relational databases (e.g. PostgreSQL/MySQL) for structured data like vehicle listings and transactions; NoSQL databases (e.g. MongoDB) for unstructured data such as images and logs; and caching systems (e.g. Redis) to enhance performance for frequent queries. Other external components that may be coupled to machine 12 comprise: OEM inventory systems, dealership management systems; financial institution APIs for loan processing; charging infrastructure management systems, and logistics provider systems. RESTful APIs for frontend-backend communication may be employed, including integration APIs for OEMs, charging providers, and logistics partners.

Further, the processor 14 is capable of executing the instructions in memory 16 to implement aspects of processes described herein. For example, processor 14 may be embodied as an executor of software instructions, wherein the software instructions may specifically configure processor 14 to perform algorithms and/or operations described herein when the software instructions are executed. Alternatively, processor 14 may be configured to execute hard-coded functionality. Computerized system 10 may be software (e.g., code segments compiled into machine code), hardware, embedded firmware, or a combination of software and hardware, according to various embodiments.

Examples of the I/O module 18 include, but are not limited to, an input interface and/or an output interface. Some examples of the input interface may include, but are not limited to, a keyboard, a mouse, a joystick, a keypad, a touch screen. Some examples of the output interface may include, but are not limited to, a microphone, a speaker, a ringer, a graphical user interface 28. In an example embodiment, processor 14 may include I/O circuitry configured to control at least some functions of one or more elements of I/O module 18, such as, for example, a speaker, a microphone, a display 28, and/or the like. Processor 14 and/or the I/O circuitry may be configured to control one or more functions of the one or more elements of I/O module 18 through computer program instructions, for example, software and/or firmware, stored on a memory, for example, the memory 16, and/or the like, accessible to the processor 14.

A communication interface associated with the I/O module 18 enables computing system 12 to communicate with other entities over various types of wired, wireless or combinations of wired and wireless networks 30, such as for example, the Internet. The communication interface facilitates communication between the computing system 12 and I/O peripherals. In at least one example embodiment, the communication interface includes a transceiver circuitry configured to enable transmission and reception of data signals over the various types of communication networks. In some embodiments, the communication interface may include appropriate data compression and encoding mechanisms for securely transmitting and receiving data over the communication networks. In one example, the platform is deployed on cloud services (such as AWS, Azure, or Google Cloud) with auto-scaling capabilities to handle variable traffic demands.

Centralized circuit system 20 may be various devices configured to, among other things, provide or enable communication between the components (14-18) of computing system 12. In certain embodiments, centralized circuit system 20 may be a central printed circuit board (PCB) such as a motherboard, a main board, a system board, or a logic board. Centralized circuit system 20 may also, or alternatively, include other printed circuit assemblies (PCAs), communication channel media or bus.

A plurality of user computing devices 32 and data sources 34 are coupled to computing system 12 with a communication network 30. User computing devices 24 can therefore access machine 12. The machine 12 provides a web interface accessible from desktop and mobile devices 32, and includes responsive design ensuring compatibility across different screen sizes.

Machine 12 may be operable to register and authenticate users (using a login, unique identifier, and password for example) prior to providing access to applications, a local network, network resources, other networks and network security devices.

In an example, the processor 14 can execute instructions in memory 16 to configure a data pre-processing module 40, a matching module 42, and a recommendation module 44. In more detail, the matching module 42, and the recommendation module 44 comprise a suite of algorithms which receive pre-processed data derived from a plurality of raw data sources 26. The processor 14 is configured by the machine executable instructions to initiate and acquire raw data for input into the data pre-processing module 40; and the processor 14 implements the machine executable instructions to configure the matching module 40, and the recommendation module 42 using data models to generate recommendations for the custom vehicle based on at least one of user preferences, vehicle type, body type, components, grants, financing, vehicle support infrastructure, jurisdiction.

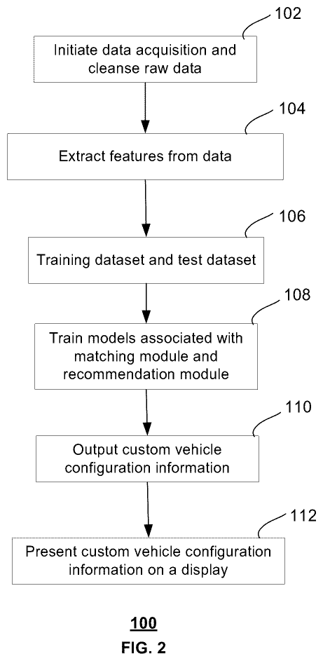

FIG. 2 shows a flow chart 100 outlining example steps for customizing a vehicle build. In step 102, raw data is gathered from various sources, and may represent elements such as, vehicle type, body type, vehicle, components, grants, financing, rebates, services, vehicle support infrastructure, jurisdiction. The data may include original equipment manufacturer (OEM) and upfitter information such as specifications, invoices, status and so forth; accessories, logistics, manuals. The data may be in a plurality of formats, such as, paper forms, spreadsheets, PDFs, flat files and business processes. The data pre-processing module 42 receives the raw data and structures and scrubs the data for anomalies and null values, and standardizes the raw data to form structured data.

In step 104, features of the data are extracted from the data to generate feature vectors. Accordingly, the algorithms extract, translate, map the input data to features, and deploy the data. The algorithms comprise custom steps or routines and processes based on complex business processes, integrated logics and eco-system data. For example, the processes are intelligently contextualized and stitched with downstream and upstream business processes; and public and private data may be overlayed on the stitched data to achieve better outcomes.

In step 106, the structured data and feature vectors are used to train the machine learning models to provide recommendations for the custom vehicle based on at least one of user preferences, vehicle type, body type, components, grants, financing, vehicle support infrastructure, jurisdiction, and so forth.

In step 108, the training data set and the feature vectors are used to fully train one or more models associated with the matching module 44 and recommendation module 46. The input training datasets and the feature vectors are fed into a matching module 42 comprising machine learning models for matching upfittings with chassis and cab types, to enable customization. The input training datasets and the feature vectors are fed into a recommendation module 44 comprising machine learning models for providing recommendations based on different manufacturing products, including charging infrastructure and financing options, integrating body, chassis, and services e.g. financing and grants, creating a seamless end-to-end solution. The models enable smart decision-making through automated decision trees, reducing the time and complexity associated with matching products and services during the manufacturing process.

In one example, the training data comprises multiple data types from across the commercial vehicle ecosystem, such as: vehicle specification data comprising detailed information about vehicle configurations, including battery performance, range, payload capacity, and drivetrain specifications; transaction history data comprising records of completed sales with pricing information and configuration details; user behavior data comprising search patterns, configuration preferences, and buying behaviors; charging infrastructure data comprising compatibility requirements and installation specifications; financial data comprising loan terms, incentive program information, and total cost of ownership metrics; integration data comprising information flows between OEMs, dealers, upfitters, and service providers; and temporal data comprising seasonal trends, market fluctuations, and inventory cycles.

In one example, the platform employs supervised learning techniques for its core functionality, particularly in predicting user behavior, optimizing vehicle configurations, and matching buyers with appropriate inventory. There are also elements of unsupervised learning used in the data normalization and data “stitching” processes, which handle complex, heterogeneous data sources from across the mobility ecosystem. The system's recommendation and optimization components incorporate reinforcement learning techniques in specific modules.

Different machine learning classifiers or algorithms are used for building the models, such as, supervised learning algorithms, unsupervised learning algorithms and reinforcement learning algorithms. Examples of supervised learning algorithm systems include support vector machine, decision tree, linear regression, logistic regression, naive Bayes, k-nearest neighbor, random forest, AdaBoost, XGBoost, and neural network methods. Examples of unsupervised learning algorithm systems include K-means, mean shift, affinity propagation, hierarchical clustering, DBSCAN (density-based spatial clustering of applications with noise), Gaussian mixture modeling, Markov random fields, ISODATA (iterative self-organizing data), and fuzzy C-means systems. Generally, training the predictive models involves optimizing the parameters of a predictive system to minimize the loss function e.g. cross-entropy loss for classification tasks such as matching users with appropriate vehicle configurations; and mean squared error (MES) for regression tasks including pricing optimization and total cost of ownership predictions; and specialized custom loss functions that incorporate domain-specific constraints and business rules for commercial vehicle transactions.

For example, cross-entropy loss is used for classification tasks such as: matching buyers with appropriate inventory; categorizing vehicle configurations by application suitability; and identifying relevant financing options and incentive programs. Mean Squared Error (MSE) is used for regression tasks including: predicting optimal pricing; forecasting total cost of ownership; estimating infrastructure requirements; and calculating residual value projections. Custom loss functions are applied to specialized tasks including optimizing complex vehicle configurations with multiple dependencies; balancing multiple stakeholder requirements in transaction workflows; and coordinating timing of multi-step processes across the vehicle lifecycle.

The system 10 employs several optimization algorithms based on the complexity of the mobility platform, such as, Adaptive Moment Estimation (Adam) for efficiently handling sparse gradients in the recommendation systems; stochastic Gradient Descent (SGD) with momentum for training the core prediction models; AdaGrad or RMSProp for adapting to varying learning rates needed across different data types; and L-BFGS for optimization tasks requiring higher precision in convergence.

In one example, the training process comprises hyperparameters such as: learning rate for controlling the step size during gradient descent optimization; batch size for determining the number of training examples processed before model updates; number of hidden layers and units for defining the network architecture complexity; dropout rates for managing overfitting by randomly deactivating neurons during training; regularization parameters for controlling model complexity through L1 or L2 regularization; embedding dimensions for categorical features representing entities in the mobility ecosystem; attention mechanisms parameters for controlling how the model weighs different input features; and early stopping criteria for determining when to halt training based on validation performance.

Furthermore, the architecture uses a hybrid approach comprising (i) pre-trained components with fixed embeddings for common vehicle specifications and industry-standard configurations; (ii) separately trained components comprising specialized modules for distinct functions (pricing, configuration, matching) trained independently with domain-specific data; and jointly trained elements for end-to-end training for integrated processes such as the complete transaction workflow. This multi-tiered approach allows for specialized optimization of different system components while maintaining coherence in the overall platform functionality.

In one example, the network trained may be trained in multiple phases. For example, in an initial phase individual component training with domain-specific data; in an integration phase, fine-tuning interconnected components with combined datasets; and in a deployment phase, continuous learning from real-world transactions and user interactions; in an adaptation phase, there is periodic retraining to incorporate new vehicle types, regulatory changes, and market trends. This phased approach enables the system 10 to maintain specialization in distinct tasks while ensuring coherent operation across the complete mobility platform.

In addition to the training step, the models also undergo validation using test datasets. In one example, the models are trained using supervised learning with tagged input-output pairs, learning to recognize patterns and make informed recommendations. Weights are applied to variables, and the models generate recommendations and insights for the vehicle build process. In one example, the models may receive user inputs via voice, text and video as part of the vehicle customization process. Accordingly, the outputs are analyzed to classify, recommend, and suggest actions, guiding vehicle manufacturing and service integration.

In step 110, an output report comprising information of the custom vehicle is presented. The output report may comprise vehicle configuration, pricing, and financing options, and may facilitate quoting for vehicle procurement.

In step 112, the output report may be presented through a web platform via APIs and applications, and may be displayed on a user interface associated with machine 12 or user device 32.

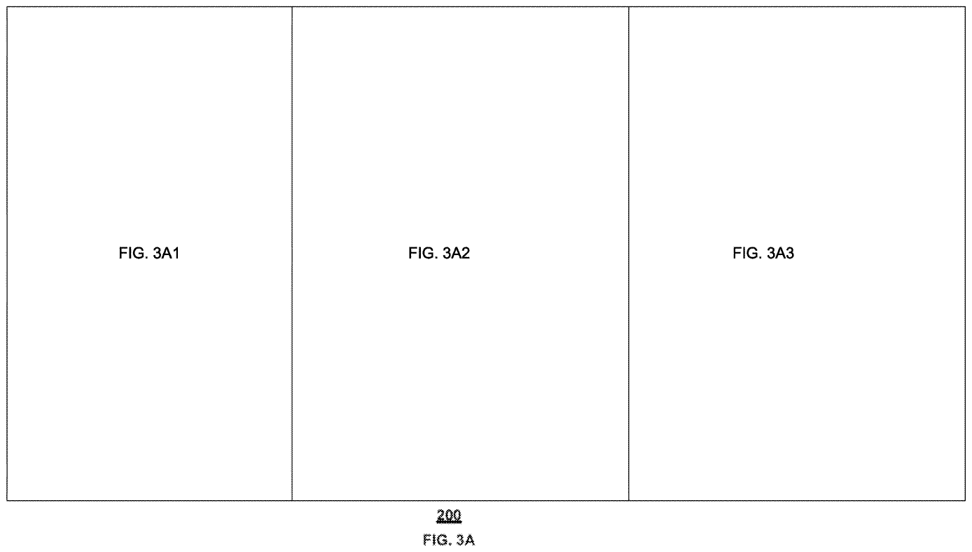

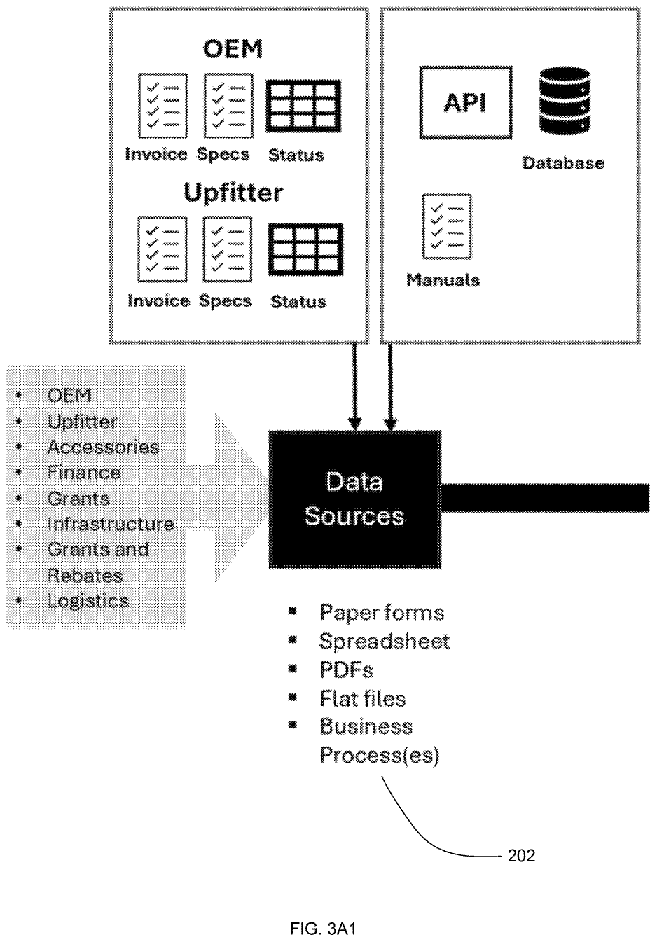

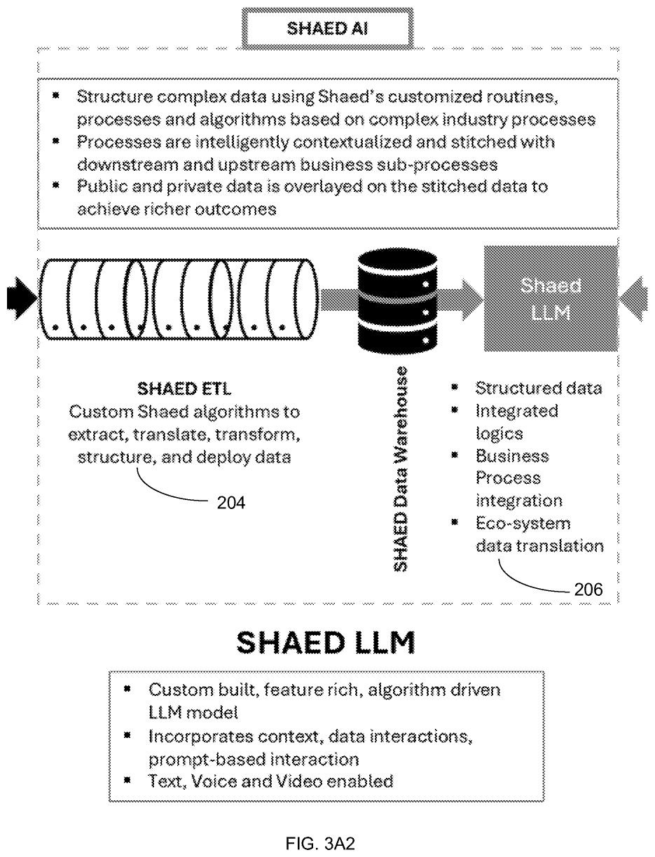

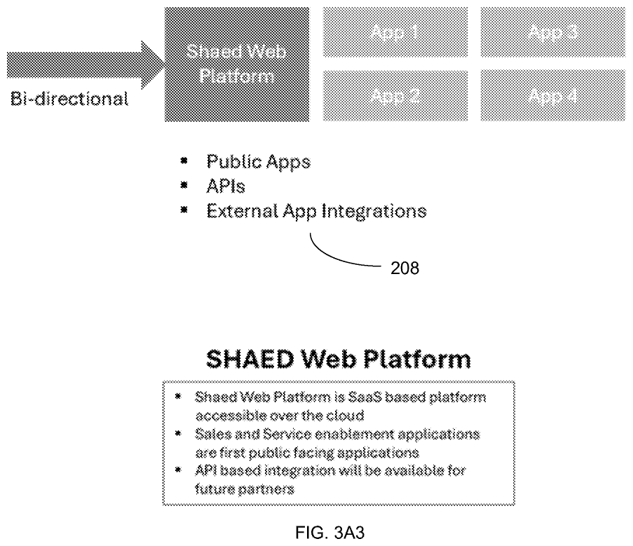

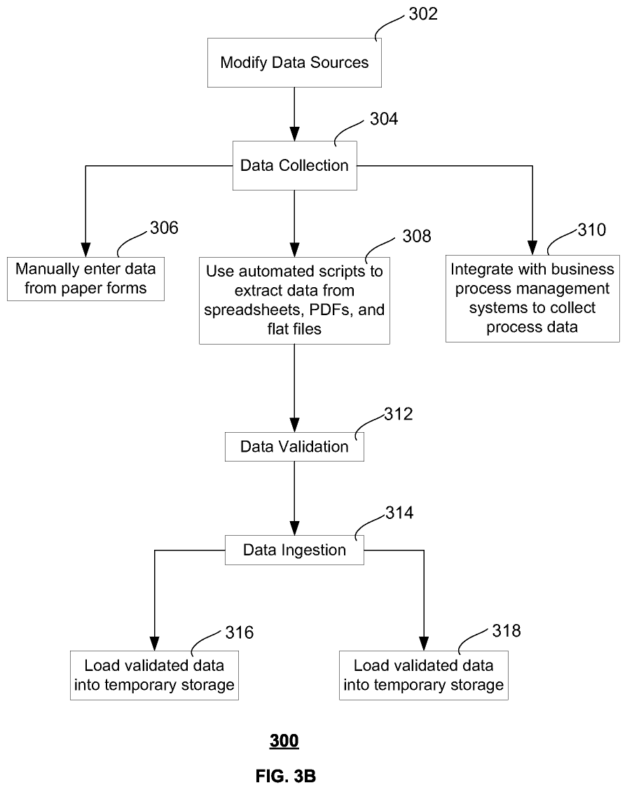

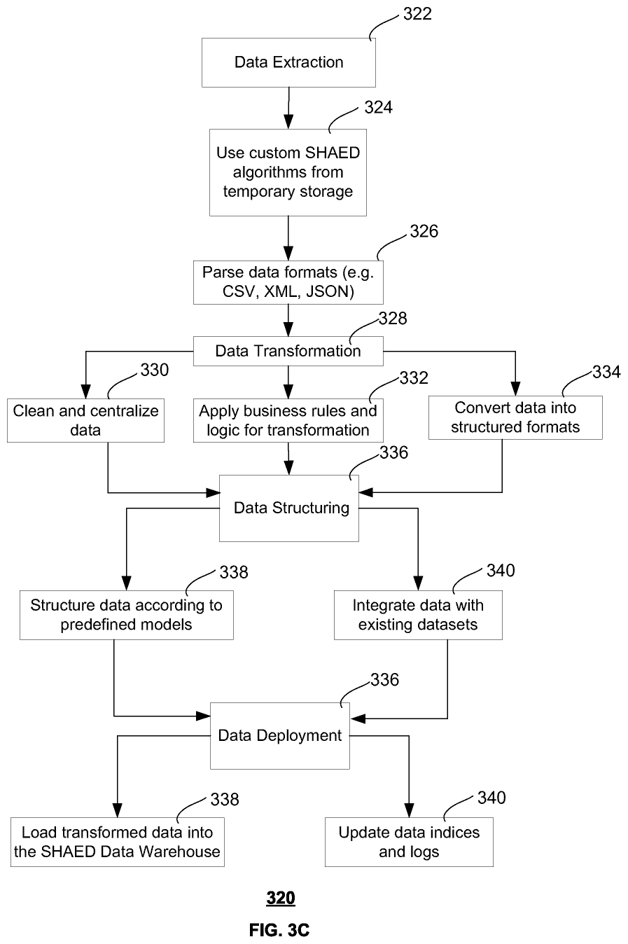

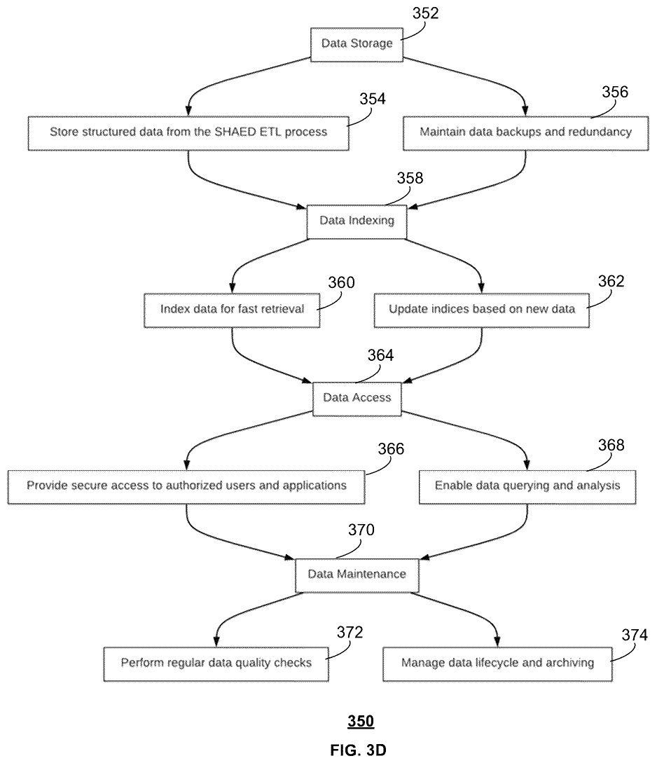

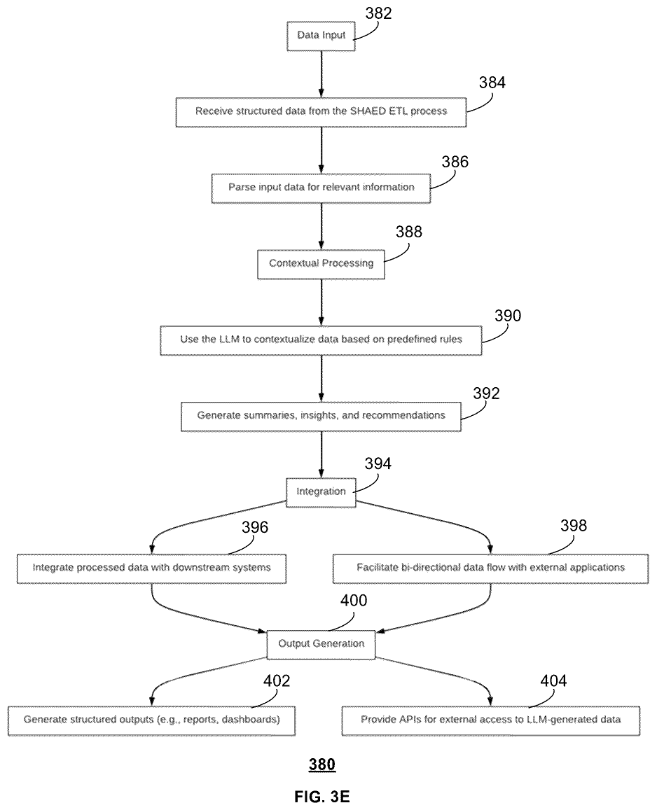

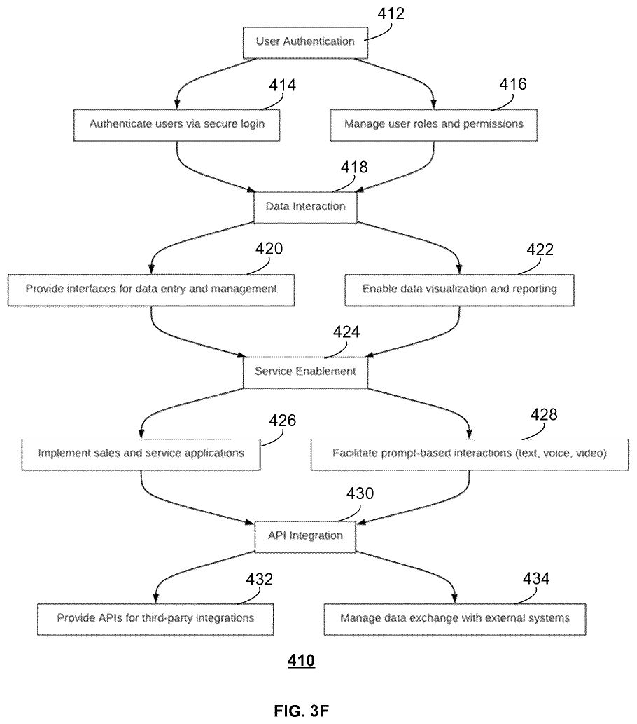

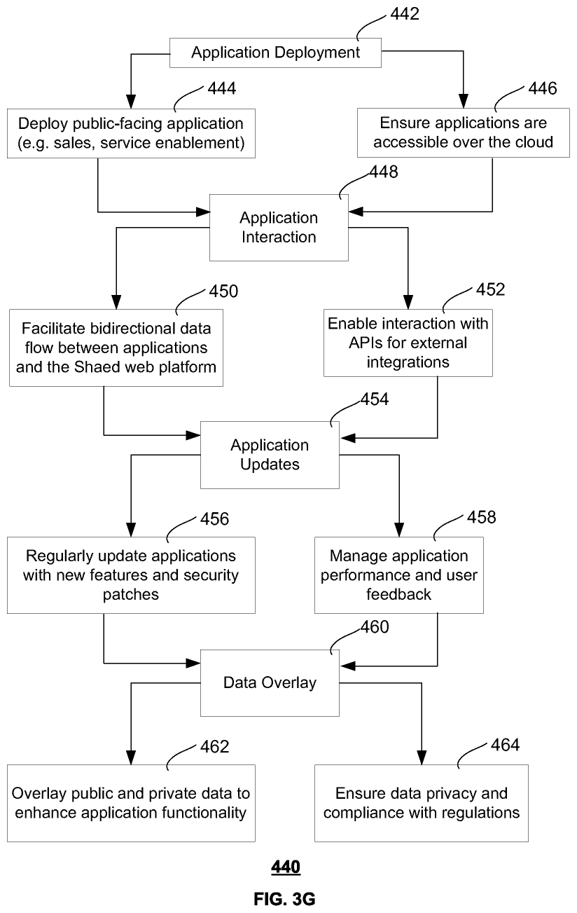

FIG. 3A, with partial views FIG. 3A1, FIG. 3A2, and FIG. 3A3, show an overall workflow 200 with example steps for vehicle procurement, which includes manufacturing integration by integrating the body, chassis, and charger components are integrated into a cohesive workflow, streamlining the manufacturing process; incorporating services such as financing, rebates, grants, among others, into the vehicle build process, and connecting the manufacturing workflow to essential services; providing an intelligent recommendation engine comprising machine learning techniques to match upfittings with chassis and cab types, as well as recommend appropriate charging infrastructure and financing options; thereby providing a seamless process from manufacturing to sales and support.

In step 202, as shown in FIG. 3A1, raw data is acquired from various sources, and may represent elements such as, vehicle type, body type, vehicle, components, grants, financing, rebates, services, vehicle support infrastructure, jurisdiction. The data may include original equipment manufacturer (OEM) and upfitter information such as specifications, invoices, status and so forth; accessories, logistics, manuals. The data may be in a plurality of formats, such as, paper forms, spreadsheets, PDFs, flat files and business processes. Machine 12 is coupled to other physical systems, such as (i) charging infrastructure integration or charging station networks to provide real-time data on charging availability and to coordinate installation of new infrastructure; (ii) vehicle telematic systems to collect operational data that informs maintenance scheduling and performance analytics; (iii) logistics tracking systems, that is, integration with logistics providers enables real-time tracking of vehicle deliveries and transportation status; and (iv) energy management systems to optimize charging schedules and manage power consumption. These integrations enable the platform to bridge the digital and physical aspects of commercial vehicle operations.

In more detail, the machine 12 ingests a variety of types of data, such as: vehicle specification data comprising detailed technical specifications of commercial vehicles including dimensions, powertrain details, payload capacities, and compatibility requirements; pricing and financial data comprising MSRP, dealer pricing, financial terms, lease options, and total cost of ownership parameters; infrastructure data comprising charging station specifications, installation requirements, power delivery capabilities, and grid connection parameters; geographic and operational data comprising route information, service territories, terrain characteristics, and climate conditions that affect vehicle performance; regulatory and compliance data comprising emissions standards, safety requirements, incentive program details, and regional regulations affecting vehicle deployment; user and stakeholder data comprising dealer information, fleet operator requirements, upfitter capabilities, and service provider details; and temporal data comprising historical pricing trends, seasonal demand patterns, and market evolution indicators.

The data is collected through multiple channels, such as: direct API integrations comprising real-time connections to dealer management systems, OEM databases, and service provider platforms; structured data feeds comprising regular automated imports from industry databases, pricing services, and specification repositories; web data extraction comprising automated collection of publicly available vehicle information, market data, and regulatory updates; user-generated content comprising data submitted through the platform by dealers, fleet operators, and service providers; IoT and telematics comprising vehicle performance data collected from connected commercial vehicles (with appropriate permissions); dedicated partnerships comprising specialized data streams from strategic partners including OEMs, charging networks, and finance providers; and federated learning nodes comprising distributed learning systems that extract patterns without centralizing raw data, preserving stakeholder privacy.

In step 204, as shown in FIG. 3A2, the data pre-processing module 42 receives the raw data and structures and scrubs the data for anomalies and null values, and standardizes the raw data to form structured data. The data pre-processing module 42 uses custom algorithms with an ETL architecture to extract (read) data from a data source, transform (e.g., cleanse, summarize) the data, and the load the data in a target data store (e.g., a data warehouse).

More specifically, the data pre-processing module 42 handles data diverse data sources across the commercial vehicle ecosystem, and performs the following functions:
data normalization, in which heterogeneous vehicle data from multiple sources (OEMs, dealers, upfitters) undergoes normalization to create standardized formats. For example, data normalization includes normalizing vehicle specifications, pricing data, and configuration options across different manufacturers and models;
data cleaning, where automated validation processes identify and correct inconsistencies, missing values, and errors in vehicle listings and specifications, which substantially ensures data integrity before entering the artificial intelligence processing pipeline;
feature engineering, in which raw vehicle data is transformed into meaningful features for the AI models, including: extracting technical specifications for comparison algorithms; deriving pricing features for valuation models; computing energy efficiency metrics for EV-specific analyses; and creating categorical encodings for vehicle types and configurations;
data stitching, in which novel proprietary data stitching technology integrates information from disconnected sources to create unified, comprehensive vehicle profiles, which combines specifications, pricing, availability, charging capabilities, and service history into coherent datasets;
contextual enrichment, in which vehicle data is enriched with contextual information including: regional incentive and tax credit data for EVs; local charging infrastructure availability; market pricing trends; historical transaction data; and
dimensionality reduction, in which for complex vehicle datasets with numerous attributes, dimensionality reduction techniques isolate the most relevant features for specific prediction tasks.

In step 206, as shown in FIG. 3A2, the algorithms, comprising custom steps or routines and processes based on complex business processes, integrated logics and eco-system data, are executed, and the structured data and feature vectors are used to train the machine learning models to provide personalized recommendations for the custom vehicle based on at least one of user preferences, vehicle type, body type, components, grants, financing, vehicle support infrastructure, jurisdiction, fleet requirements, and operational constraints and so forth.

In one example, the recommendations are output from the models in a multi-format visualization format via a web platform and associated applications, as shown in FIG. 3A3 in step 208. For example, the analytical outputs are rendered through: interactive dashboards displaying inventory performance; comparative visualizations for vehicle options; total Cost of Ownership (TCO) calculators with configurable parameters; geospatial representations of charging infrastructure availability.

The AI-derived insights are seamlessly integrated into transaction workflows, for example, the automated pricing recommendations feed into quotation systems; vehicle matching results trigger notification systems; predictive maintenance alerts connect to service scheduling modules; and charging optimization recommendations link to infrastructure planning tools.

Furthermore, the complex model outputs are transformed into decision support tools, such as confidence scores accompany recommendations; alternative options are ranked and presented with trade-off analyses; projected financial impacts are calculated for business decisions; risk assessments are generated for financing decisions. In addition, the models outputs may be structured for consumption by both internal platform components and external stakeholder systems through standardized APIs, enabling seamless integration across the mobility ecosystem with API-ready formatting.

In one example, the trained model receives the following inputs: vehicle specifications and attributes (battery performance, range, payload capacity, etc.); user search parameters and preferences; market data including pricing trends and inventory availability; charging infrastructure specifications and compatibility requirements; and fleet operational data including routes, usage patterns, and energy needs.

In one example, the trained model generates the following outputs: personalized vehicle recommendations based on specific operational requirements; total Cost of Ownership (TCO) projections accounting for vehicle type, charging needs, and operational patterns; optimized charging infrastructure recommendations based on fleet size and operational routes; predictive maintenance schedules to maximize uptime; and residual value projections for commercial EVs to enable accurate financing and lifecycle planning.

As such, the trained model is capable of making predictions or generating outputs on new, unseen data, that is, by an inference method. In one example, the inference method is enabled by a component-based architecture which uses a hybrid model combining supervised learning for structured data processing with reinforcement learning components for optimization tasks. Specialized neural network layers are configured specifically for handling the complex relationships between vehicle configurations, charging requirements, and operational parameters. For example, the architecture implements a novel attention mechanism that prioritizes critical vehicle attributes based on specific use cases, and uses a federated approach that maintains data privacy while enabling cross-fleet learning. Furthermore, the architecture incorporates a specialized transformer architecture modified to handle the sequential nature of vehicle lifecycle events.

Through the specialized attention mechanisms, the inference method requires reduced computational requirements compared to standard commercial vehicle analysis systems, and provide significantly improved accuracy in TCO calculations by incorporating previously unlinked data sources. Furthermore, the inference method enables enhanced resource utilization through intelligent caching of common inference patterns, reducing redundant calculations, and lower memory footprint during inference through novel component reuse architecture. In addition, the inference method drastically reduced latency in real-time recommendation generation enabling interactive user experiences.

The trained model is updated as a result of the inference, and implements a novel continuous learning approach, in which transaction outcomes provide feedback loops that refine prediction accuracy. A specialized transfer learning mechanism allows knowledge gained from one vehicle type to improve predictions for related configurations; anomaly detection algorithms automatically identify and flag unusual patterns for human review before incorporation; federated learning techniques allow model improvements without compromising sensitive customer data; and incremental update mechanisms reduce retraining costs while maintaining performance improvements.

The system 10 is specifically designed to handle evolving input data, as new vehicle configurations and specifications are continuously incorporated through our dynamic schema adaptation mechanism. Also, changing market conditions are detected through a drift detection algorithm which triggers targeted retraining of the model. Emerging charging technologies and standards are accommodated through our extensible charging parameter framework, including regulatory changes (incentives, requirements) are incorporated through a specialized rule engine that interfaces with the ML components. The system 10 employs data normalization techniques to maintain prediction accuracy despite evolving vehicle technology specifications.

In one example, the system 10 comprises a machine learning approach and architecture comprising a “Component Optimization and Reuse Engine” (CORE), addresses the fundamental technical challenges in commercial EV transactions. Specifically, the specialized transformer-based architecture treats vehicle components as “ingredients” with complex interdependencies, and implements a novel attention mechanism that dynamically weights the importance of vehicle attributes based on specific use cases and operational requirements. Advantageously, a unique embedding space for representing vehicle configurations that preserves compatibility relationships between components is created. The component reuse framework (CORE) algorithm significantly reduces computational complexity compared to standard approaches, and memory utilization is optimized through a novel caching system that identifies common inference patterns. The training process is more efficient through a transfer learning approach that leverages knowledge across vehicle categories. In addition, the system 10 implements a specialized form of contrastive learning to better distinguish subtle differences between similar vehicle configurations, including a multi-objective optimization framework that simultaneously considers range, payload, and cost factors; and a novel reinforcement learning environment that simulates full vehicle lifecycle to optimize long-term TCO. The unique federated learning implementation allows collaborative model improvement while maintaining data privacy. A specialized curriculum learning approach that progressively introduces more complex vehicle configurations is implemented, and includes a novel regularization technique specific to vehicle attribute relationships that prevents overfitting.

These innovations collectively solve the fundamental technical problem of computational efficiency and accuracy in modeling complex relationships between vehicles, infrastructure, and operational requirements.

The above-noted specialized neural architecture reduces memory utilization and computational requirements compared to using generic transformer models for the same tasks. The graph-based representation reduces complex relational queries, enabling real-time responses even with massive datasets. The adaptive API connectors reduce integration overhead by automatically mapping and normalizing external data structures, reducing integration time from weeks to hours. The dynamic workload balancing system optimizes cloud resource allocation based on transaction patterns, reducing computing costs compared to static allocation.

Additionally, the method and systems improve the technical field of commercial vehicle transactions by: (i) digitizing previously manual processes, automating document processing, regulatory compliance checking, and multi-stakeholder coordination; (ii) enabling real-time configuration validation: Verifying that vehicle configurations meet all technical and regulatory requirements instantly rather than through days of manual checking; and optimizing charging infrastructure deployment: providing data-driven recommendations for charging station placement and capacity based on predicted fleet movements. These improvements are realized by (a) graph-augmented transformer architecture, which represents entities (vehicles, dealers, services) as nodes in a graph and their relationships as edges, enabling the architecture to efficiently model complex interdependencies while preserving the contextual understanding capabilities of the transformers; (b) hierarchical attention mechanisms, in which the model employs multi-level attention that operates both within and across stakeholder domains, allowing it to focus on relevant information at different granularities; (c) dynamic schema adaptation, as the system 10 employs a meta-learning approach that enables it to quickly adapt to new data schemas without requiring complete retraining; (d) a federated learning approach, in which neural network architecture enables collaborative model improvement across stakeholders while preserving data privacy, allowing the system 10 to learn from distributed data sources; and (e) contrastive learning for vehicle representation which uses specialized contrastive learning techniques to develop rich vector representations of vehicles that capture both explicit specifications and implicit characteristics.

In traditional data cleaning approaches cascading errors are created due to interdependencies between data points, and therefore data quality degrades with scale. The system 10 implements a self-correcting data validation architecture that employs confidence scoring and semantic consistency checking to detect and repair data inconsistencies.

For new vehicle models e.g. EV models which lack historical data for pricing and configuration recommendation, a few-shot learning approach that transfers knowledge from similar vehicle categories while preserving unique characteristics of new models is implemented. Commercial vehicle pricing and availability fluctuate based on market conditions, which can cause model performance to degrade over time. The methods and systems described herein implement an adaptive retraining system that monitors prediction accuracy and automatically triggers targeted retraining when accuracy falls below predefined thresholds.

FIG. 3B shows a workflow 300 outlining how various data sources are integrated into the system 10. The workflow comprises the steps of: (i) identifying data sources, such as paper forms; spreadsheets; PDFs; flat files; business processes (302); (ii) data collection (304) comprising: manual entry for paper forms (306); automated scripts for extracting data from spreadsheets, PDFs, and flat files (308); integration with business process management systems to collect process data (310); (iii) data validation (312) comprising checking data formats and consistency and validating data against predefined schemas; and (iv) data ingestion (314) comprising loading data into temporary storage for initial processing (316); and logging ingestion status and errors (318).

FIG. 3C shows a workflow 320 outlining the extraction, transformation, and loading of data using system 10's custom algorithms. The workflow comprises the steps of: (i) data extraction (322) which uses custom algorithms to extract data from temporary storage (324) and parses data formats (e.g., CSV, XML, JSON) (326); (ii) data transformation (328) comprising cleaning and normalizing data (330); applying business rules and logic for transformation (332); converting data into structured formats (334); (iii) data structuring (336) comprising structuring data according to predefined model (338) and integrating data with existing datasets (340); (iv) data deployment (342) comprising loading transformed data into the system's 10 data warehouse (344) and updating data indices and logs (346).

FIG. 3D shows a workflow 350 outlining the management and utilization of the system's data warehouse. The workflow comprises the steps of: (i) data storage (352) comprising storing structured data from the ETL process (354); maintaining data backups and redundancy (356); (ii) data indexing (358) comprising indexing data for fast retrieval (360); updating indices based on new data (362); (iii) data access (364) comprising providing secure access to authorized users and applications (366) and enabling data querying and analysis (368); and (iv) data maintenance (370) comprising performing regular data quality checks (372) and managing data lifecycle and archiving (374).

FIG. 3E shows a workflow 380 outlining the operations of the system's language model, focusing on data processing and interaction. The workflow 380 comprises the steps of:
(i) data input (382) comprising: receiving structured data from the ETL process (384) and parsing input data for relevant information (386); (ii) contextual processing (388) comprising using the LLM to contextualize data based on predefined rules (390); and generating summaries, insights, and recommendations (392); (iii) integration (394) comprising integrating processed data with downstream systems (396) and facilitating bi-directional data flow with external applications (398); and output generation (400) comprising generating structured outputs (e.g., reports, dashboards) (402); and provide APIs for external access to LLM-generated data (404).

The system 10 comprises a neural network comprising a plurality of layers, such as a data normalization layer, a feature extraction layer, a prediction layer, and a recommendation layer. The data normalization layer comprises a circuit for transforming raw data in disparate formats acquired from a plurality of data sources into structured data in a standardized data format. The data normalization layer data employs cleaning and preprocessing techniques to handle missing values and outliers, and applies feature scaling for consistent ranges across the plurality of data sources. The feature extraction layer comprises a circuit for identifying relevant attributes from the structured data to form training data; and uses dimensionality reduction techniques to manage the high-dimensionality of vehicle data. The prediction layer comprises a third circuit for vehicle pricing and valuation predictions using the training data to train predictive models; the prediction layer comprises regression models for pricing and valuation predictions, comprises ReLU activation functions in hidden layers for training efficiency, and further comprises softmax activation for classification tasks including vehicle categorization. The recommendation layer comprises a fourth circuit having collaborative filters to provide personalized vehicle inventory recommendations. For example, the recommendation layer employs similarity metrics to identify relevant vehicle matches and employs sigmoid activation functions for binary preference predictions.

The layers within the architecture may be connected through (i) forward propagation, in which data flows through the normalized input layer through hidden layers to produce recommendations and predictions; (ii) API Interfaces, where each machine learning component exposes APIs that allow other services to consume their output; (iii) event messaging, in which components communicate through an event-based system 10 that allows for real-time updates and asynchronous processing; (iv) data exchange protocols, where standardized data formats facilitate information exchange between components; (iv) feedback loops, such that the system 10 incorporates user interactions and transaction completions to continuously improve model accuracy.

FIG. 3F shows a workflow 410 outlining the interaction between users and the web platform. The workflow comprises the steps of: (i) user authentication (412) comprising authenticating users via secure login (414) and managing user roles and permissions (416); (ii) data interaction (418) comprising providing interfaces for data entry and management (420) and enabling data visualization and reporting (422); (iii) service enablement (424) comprising implementing sales and service applications (426); and facilitating prompt-based interactions (text, voice, video) (428); and (iv) API integration (430) comprising providing APIs for third-party integrations (432) and managing data exchange with external systems (434).

FIG. 3G shows a workflow 440 outlining the deployment and interaction of various applications. The workflow 440 comprises the steps of: (i) application deployment (442) comprising deploying public-facing applications (e.g., sales, service enablement) (444) and providing that applications are accessible over the cloud (446); (ii) application interaction (448) comprising facilitating bi-directional data flow between applications and the web platform (450); and enabling interaction with APIs for external integrations (452); (iii) application updates (454) comprising regularly updating applications with new features and security patches (456); and managing application performance and user feedback (458); and (i) data overlay (460) comprising overlaying public and private data to enhance application functionality (462); and ensuring data privacy and compliance with regulations (464).

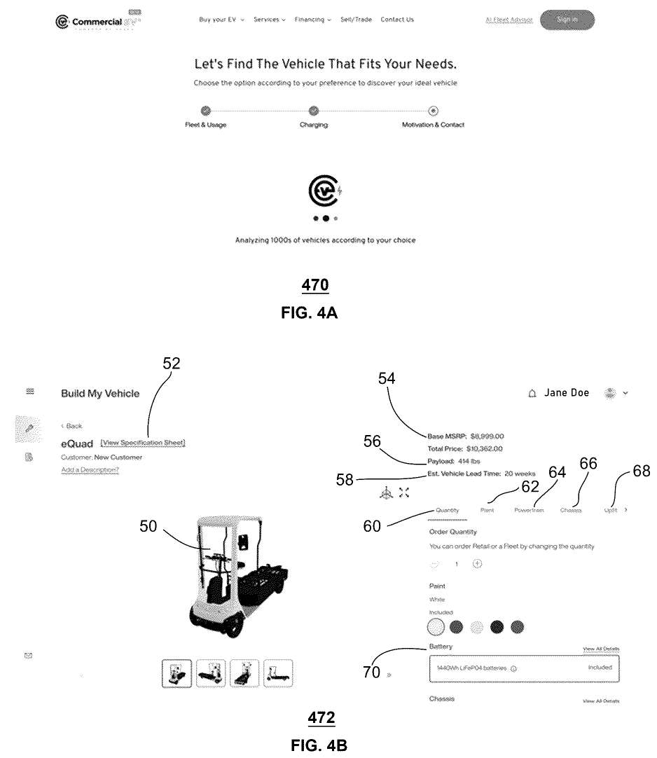

FIG. 4A shows an example user interface 470 of a sales portal for an AI-enabled search capable of analyze a multitude of vehicles to find the right for vehicle, charger, infrastructure, rebates and incentives to suit a user's preferences.

FIG. 4B shows an example user interface 472 of a sales portal for customizing an electric vehicle 50 for procurement. The user interface 472 comprises specification information 52, pricing information 54, payload 56, expected lead time 58, and various options such as quantity 60, parts 62, powertrain 64, chassis 66, upfitting 68, and battery 70. For example, the system 10 automatically identifies required chargers, infrastructure and potential rebates and incentives available based on location e.g. zip code.

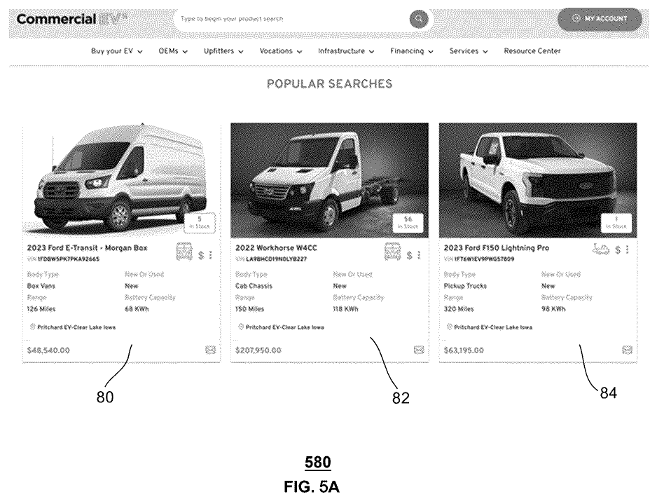

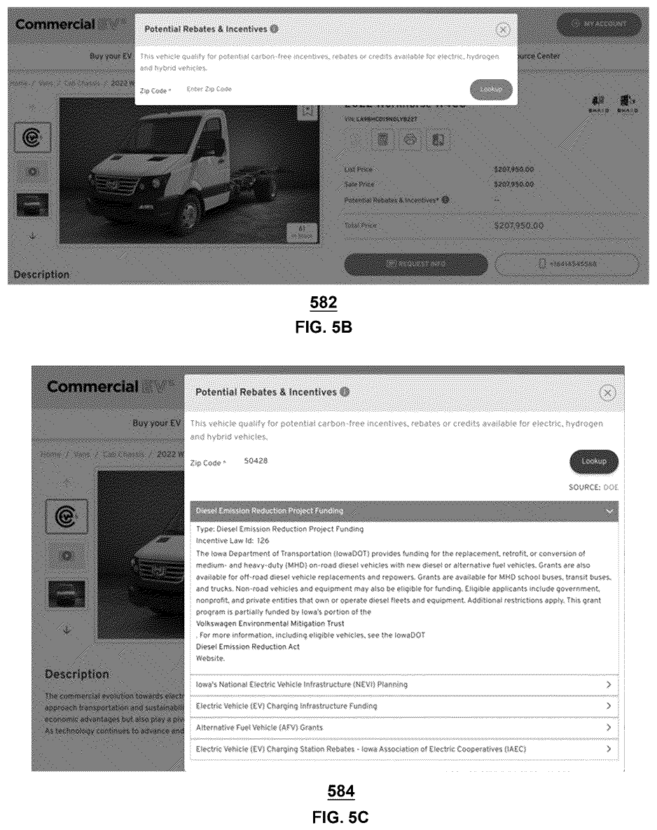

FIG. 5A shows an example user interface 580 with vehicle 50 listings for purchase.

FIG. 5B shows an example user interface 582 showing potential rebates and incentives. In one example, the system algorithms associated with the matching module 42 and/or recommendation module 44 automatically identify required chargers, infrastructure and potential rebates and incentives available by zip code.

FIG. 5C shows an example user interface 584 showing funding and rebate information.

In another example, the system 10 includes prompt-based voice/text (e.g. AI chatbots) for vehicle configuration and vehicle procurement process, intelligent infrastructure and charging integration, document reading, and invoice generation.

In another example, the system 10 is capable of running several applications using a common data structure, consolidation of complex business processes, and integrating the sales lifecycle. In another example, the AI capability may be made available to trusted partners and customers enabling them to build their own custom applications and solutions.

In one implementation, processor 14 may be embodied as a multi-core processor, a single core processor, or a combination of one or more multi-core processors and one or more single core processors. For example, processor 14 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, Application-Specific Standard Products (ASSPs), System-on-a-chip systems (SOCs), Complex Programmable Logic Devices (CPLDs), Programmable Logic Controllers (PLC), Graphics Processing Units (GPUs), and the like. For example, some or all of the device functionality or method sequences may be performed by one or more hardware logic components.

Memory 16 may be embodied as one or more volatile memory devices, one or more non-volatile memory devices, and/or a combination of one or more volatile memory devices and non-volatile memory devices. The term “machine readable medium” can include any medium that is capable of storing, encoding, or carrying instructions for execution by the machine 12 and that cause the machine 12 to perform any one or more of the techniques of the present disclosure, or that is capable of storing, encoding or carrying data structures used by or associated with such instructions. Nonlimiting machine-readable medium examples can include solid-state memories, and optical and magnetic media. Specific examples of machine-readable media can include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media can include non-transitory machine-readable media. In some examples, machine readable media can include machine readable media that is not a transitory propagating signal.

The communication interface enables computing system 12 to communicate with other entities over various types of wired, wireless or combinations of wired and wireless networks, such as for example, the Internet. In at least one example embodiment, the communication interface includes a transceiver circuitry configured to enable transmission and reception of data signals over the various types of communication networks. In some embodiments, communication interface may include appropriate data compression and encoding mechanisms for securely transmitting and receiving data over the communication networks. Communication interface facilitates communication between computing system 12 and I/O peripherals.

It is noted that various example embodiments as described herein may be implemented in a wide variety of devices, network configurations and applications.

Those of skill in the art will appreciate that other embodiments of the disclosure may be practiced in network computing environments with many types of computer system configurations, including personal computers (PCs), industrial PCs, desktop PCs), hand-held devices, multi-processor systems, microprocessor-based or programmable consumer electronics, network PCs, server computers, minicomputers, mainframe computers, and the like. Accordingly, system 10 may be coupled to these external devices via the communication, such that system 10 is controllable remotely. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In another implementation, system 10 follows a cloud computing model, by providing an on-demand network access to a shared pool of configurable computing resources (e.g., servers, storage, applications, and/or services) that can be rapidly provisioned and released with minimal or nor resource management effort, including interaction with a service provider, by a user (operator of a thin client).

Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, can include, or can operate on, logic or a number of components, modules, or mechanisms (all referred to hereinafter as “modules”). Modules are tangible entities (e.g., hardware) capable of performing specified operations and is configured or arranged in a certain manner. In an example, circuits are arranged (e.g., internally or with respect to external entities such as other circuits) in a specified manner as a module. In an example, the whole or part of one or more computer systems (e.g., a standalone, client or server computer system) or one or more hardware processors are configured by firmware or software (e.g., instructions, an application portion, or an application) as a module that operates to perform specified operations. In an example, the software can reside on a non-transitory computer readable storage medium or other machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor is configured as respective different modules at different times. Software can accordingly configure a hardware processor, for example, to constitute a particular module at one instance of time and to constitute a different module at a different instance of time.

Examples, as described herein, can include, or can operate on, logic or a number of components, modules, or mechanisms. Modules are tangible entities (e.g., hardware) capable of performing specified operations and are configured or arranged in a certain manner. In an example, circuits are arranged (e.g., internally or with respect to external entities such as other circuits) in a specified manner as a module. In an example, the whole or part of one or more computer systems (e.g., a standalone, client, or server computer system) or one or more hardware processors are configured by firmware or software (e.g., instructions, an application portion, or an application) as a module that operates to perform specified operations. In an example, the software can reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor is configured as respective different modules at different times. Software can accordingly configure a hardware processor, for example, to constitute a particular module at one instance of time and to constitute a different module at a different instance of time.

Various embodiments are implemented fully or partially in software and/or firmware. This software and/or firmware can take the form of instructions contained in or on a non-transitory computer-readable storage medium. Those instructions can then be read and executed by one or more processors to enable performance of the operations described herein. The instructions are in any suitable form, such as but not limited to source code, compiled code, interpreted code, executable code, static code, dynamic code, and the like. Such a computer-readable medium can include any tangible non-transitory medium for storing information in a form readable by one or more computers, such as but not limited to read only memory (ROM); random access memory (RAM); magnetic disk storage media; optical storage media; flash memory; etc.

Each of the non-limiting aspects or examples described herein can stand on its own, or can be combined in various permutations or combinations with one or more of the other examples.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

A computer program, which may also be referred to or described as a program, software, a software application, a module, a software module, a script, or code can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components, as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a GPU, an FPGA, or an ASIC.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system 10 can be interconnected by any form or medium of wireline and/or wireless digital data communication, e.g., a communications network 30. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations, and free-space optical networks. The network may communicate with, for example, Internet Protocol (IP) packets, Frame Relay frames, Asynchronous Transfer Mode (ATM) cells, voice, video, data, and/or other suitable information between network addresses.

There may be any number of computers associated with, or external to, the system 10 and communicating over network 30. Further, the terms “client,” “user,” and other appropriate terminology may be used interchangeably, as appropriate, without departing from the scope of this disclosure.

In another implementation, system 10 follows a cloud computing model, by providing an on-demand network access to a shared pool of configurable computing resources (e.g., servers, storage, applications, and/or services) that can be rapidly provisioned and released with minimal or nor resource management effort, including interaction with a service provider, by a user (operator of a thin client).

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hard-ware and computer instructions.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variations thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the disclosure unless expressly described as “essential” or “critical.”

The preceding detailed description of example embodiments of the disclosure makes reference to the accompanying drawings, which show the example embodiment by way of illustration. While these example embodiments are described in sufficient detail to enable those skilled in the art to practice the disclosure, it should be understood that other embodiments may be realized and that logical and mechanical changes may be made without departing from the spirit and scope of the disclosure. For example, the steps recited in any of the method or process claims may be executed in any order and are not limited to the order presented. Thus, the preceding detailed description is presented for purposes of illustration only and not of limitation, and the scope of the disclosure is defined by the preceding description, and with respect to the attached claims.

1. A vehicle recommendation system comprising:
a specialized data normalization architecture comprising a semantic understanding to automatically map diverse data schemas to a unified vehicle representation model;
a specialized transformer architecture associated with a graph-based data representation to capture complex multi-stakeholder relationships associated with vehicle transactions and track temporal evolution of the complex multi-stakeholder relationships; and
a multi-objective optimization sub-system comprising reinforcement learning architecture to balance vehicle transactions constraints in real-time by generating optimal transaction parameters.

2. The vehicle recommendation system of claim 1, wherein the specialized data normalization architecture receives raw data in disparate formats, wherein the data is associated with at least one of vehicle specifications, pricing, and configuration data.

3. The vehicle recommendation system of claim 1, wherein the transactions are associated with a plurality of interdependent stakeholders comprising at least one of dealers, OEMs, upfitters, and charging providers.

4. The vehicle recommendation system of claim 1, wherein the vehicle transactions constraints are simultaneously optimized across competing factors comprising at least one of vehicle specifications, charging infrastructure, financial terms, and delivery logistics.

5. The vehicle recommendation system of claim 1, further comprising a self-correcting data validation architecture employing confidence scoring and semantic consistency checking to detect and repair data inconsistencies, thereby substantially minimizing cascading errors due to interdependencies between data points.

6. The vehicle recommendation system of claim 1, further comprising an adaptive retraining sub-system that monitors prediction accuracy and automatically triggers targeted retraining when accuracy falls below predefined thresholds.

7. The vehicle recommendation system of claim 1, wherein the system is coupled to at least one charging station network to acquire real-time data on charging availability and to coordinate installation of new infrastructure.

8. The vehicle recommendation system of claim 1, wherein the system is coupled to at least one vehicle telematics system to collect operational data that informs maintenance scheduling and performance analytics.

9. The vehicle recommendation system of claim 1, wherein the system is coupled to at least one logistics provider sub-system to enable real-time tracking of vehicle deliveries and transportation status.

10. The vehicle recommendation system of claim 1, wherein the system is coupled to at least one energy management system to optimize vehicle charging schedules and manage power consumption.

11. An integrated system for vehicle procurement comprising:
a circuit for performing neural network computations for a neural network comprising a plurality of layers, wherein receive raw data from a plurality of data sources, wherein the raw data comprises a plurality of formats, the circuit comprising:
a data normalization layer for transforming raw data in disparate formats acquired from a plurality of data sources into structured data in a standardized data format, and comprising data cleaning and preprocessing techniques to handle missing values and outliers; and for applying feature scaling for consistent ranges across the plurality of data sources;
a feature extraction layer for identifying relevant attributes from the structured data to form training data;
a prediction layer for vehicle pricing and valuation predictions using the training data to train predictive models; and
a recommendation layer comprising collaborative filters to provide personalized vehicle inventory recommendations.

12. The integrated system for vehicle procurement of claim 11, wherein the prediction layer comprises regression models for pricing and valuation predictions, comprises ReLU activation functions in hidden layers for training efficiency, and further comprises softmax activation for classification tasks including vehicle categorization.

13. The integrated system for vehicle procurement of claim 11, wherein the recommendation layer employs similarity metrics to identify relevant vehicle matches and employs sigmoid activation functions for binary preference predictions.

14. The integrated system for vehicle procurement of claim 11, wherein the training data comprises at least one of vehicle specification data, transaction history data, user behavior data, charging infrastructure data, financial data, integration data, and temporal data.

15. The integrated system for vehicle procurement of claim 11, wherein training the predictive models comprises optimizing parameters of the predictive layer to minimize a loss function including cross-entropy loss for classification tasks that match users with an appropriate vehicle configuration; and mean squared error (MSE) for regression tasks including pricing optimization and total cost of ownership predictions; and specialized custom loss functions that incorporate domain-specific constraints and business rules for vehicle transactions.

16. The integrated system for vehicle procurement of claim 11, further comprising at least one of a charging station network to acquire real-time data on charging availability and to coordinate installation of new infrastructure, a vehicle telematics system to collect operational data that informs maintenance scheduling and performance analytics, a logistics provider system to enable real-time tracking of vehicle deliveries and transportation status, and an energy management system to optimize vehicle charging schedules and manage power consumption.

17. A computer-implemented method for procuring a custom vehicle, a computer comprising a hardware processor and a memory device on which instructions are encoded to cause the hardware processor to perform the steps of:
receiving raw data from a plurality of data sources, wherein the raw data comprises a plurality of formats and preprocessing the raw data;
extracting predefined content from the raw data to generate feature vectors;
generating a training data set and a test data set from output of the feature vector;
training at least one machine learning model using the training data set and test data set to generate recommendations for the custom vehicle based on at least one of user preferences, vehicle type, body type, components, grants, financing, vehicle support infrastructure, jurisdiction; and
outputting a report comprising information of the custom vehicle for facilitating procurement of the vehicle.

18. The method of claim 17, comprising the steps of transforming the raw data into structured data in a standardized data format, and comprising data cleaning and preprocessing techniques to handle missing values and outliers; and for applying feature scaling for consistent ranges across the plurality of data sources.

19. The method of claim 18, comprising the further steps of:
identifying relevant attributes from the structured data to form training data, wherein the training data comprises at least one of vehicle specification data, transaction history data, user behavior data, charging infrastructure data, financial data, integration data, and temporal data; and
training predictive model using the training data to predict vehicle pricing and valuation to provide a recommendation for the custom vehicle.

20. The method of claim 19, comprising the further steps of:
with at least one charging station network, acquiring real-time data on charging availability;
with at least one vehicle telematics system, acquiring operational data that informs maintenance scheduling and performance analytics;
with at least one logistics provider system, tracking in real-time vehicle deliveries and transportation status; and
with at least one energy management system, optimizing vehicle charging schedules and managing power consumption.
